(19) United States
(12) Patent Application Publication
(10) Pub. No.: US 2012/0329024 A1
(43) Pub. Date: Dec. 27, 2012

(54) Educational and Recreational Device

(75) Inventors: Sergey Nikolaevich Ershov, Nizhny Novgorod (RU); Malyshev Aleksandr Igorevich, Nizhny Novgorod (RU)

(73) Assignee: LOBACHEVSKY STATE UNIVERSITY OF NIZHNI NOVGOROD, Nizhny Novgorod (RU)

(21) Appl. No.: 13/546,129

(22) Filed: Jul. 11, 2012

Related U.S. Application Data
(63) Continuation of application No. PCT/RU2010/000626, filed on Oct. 28, 2010.

(30) Foreign Application Priority Data
Jan. 11, 2010 (RU) 2010100415

(51) Int. Cl. G09B 23/06

(52) U.S. Cl. 434/300

(57) ABSTRACT

The device comprises a ball and a panel that is made in the form of a periodic corrugation. The amplitude of the corrugation at least 10 times smaller than the period of corrugation, and the ball has a diameter which is at least 10 times smaller than the period of corrugation. Corrugations of the panel can be made sinusoidal, trapezoidal, triangular, or have other more complex forms. The device can be provided with a means for throwing the ball at different angles to the plane of the panel and at different initial velocities. The technical result obtained when using the claimed invention is a device that has broad potential as a visual aid in learning the peculiarities of motion of bodies under the action of external forces.

### RELATED APPLICATIONS

This application is a continuation of International Application No. PCT/RU2010/000626, filed Oct. 28, 2010, which claims priority to Russian Patent Application No. 2010100415, filed Jan. 11, 2010, both of which are incorporated herein by reference in their entirety.

### FIELD OF THE INVENTION

The present invention relates to devices that can be used as a visual aid and as a game.

### BACKGROUND OF THE INVENTION

There are many devices that combine cognitive, educational and recreational properties. Currently, such devices allowing their use in learning the laws of physics and mathematics in schools and universities, as well as in domestic environment are in great demand.

Design features of devices depend on their purpose. Thus, to convert the gravitational energy of body weight to mechanical energy of its translational motion, a two-cone body is used along with two inclined diverging planes designed to interact with the two-cone body, the device having a multiple-link construction such that the gravitational energy of the body is converted into mechanical energy of its translational motion (RU 2238593 C2, 2003 Jul. 10). To demonstrate the action of the two-coordinate law of probability distribution, the device comprises a target in a vessel with a liquid, this target being made in the form of an open vessel of smaller dimensions having radially arranged partitions (RU 2108835 C1, 1998 Apr. 20).

The present invention is aimed at creating a device that can demonstrate the dynamics of motion of a material point or an elastic body (e.g. a ball) under the influence of external forces.

The device of U.S. Pat. No. 4,358,276 A, 1982 Nov. 9, like the claimed one, demonstrates the features of the motion of bodies under the action of external forces and comprises the means to demonstrate the motions of the body under acceleration, collision, and vibration. The device includes a solid metal panel as a demonstration canvas. The panel is covered with the material that reflects the trajectory of the ball, whose motion direction is given by an external force. For such material, carbon paper is used that deforms under the action of the rolling ball. The panel is fixed on a table equipped with a mechanism imparting vibration to the panel, which provides for the formation of an undulating or dotted trace of the rolling ball on the deformable material, with a period exceeding its length. When the table vibrates in the horizontal plane, the ball trace is undulating, and when the table vibrates in the direction perpendicular to the plane of the table, the ball bounces, and its trace is in the form of dotted lines. The shape of ball trace depends on the speed of the ball determined by the frequency of the table's vibration, which is demonstrated by the proposed device.

The drawback of this device as a visual aid consists in the fact that it can only show the trajectory of the ball, depending on the direction of the applied force. At the same time, we know that it is important in the learning process to use such means, which have a learning feature determined by the learner's intellectual abilities. The device is cumbersome due to the use of mechanisms to impart vibration to the panel, and the need for constant replacement of the carbon paper limits its scope of application, preventing the device from being included into the arsenal of tools used in everyday life.

### SUMMARY OF THE INVENTION

The technical result obtained when using the claimed invention is a device that has broad potential as a visual aid in learning the peculiarities of motion of bodies under the action of external forces.

The proposed device is structurally simple and cheap. It can be used in the domestic environment as a game with educational, informative and entertaining qualities.

The technical result is achieved in the device comprising a ball and a panel by means of the panel made in the form of a periodic corrugation with an amplitude of at least 10 times smaller than the corrugation period, and the ball that has a diameter at least 10 times smaller than the period of corrugation.

Corrugation of the surface can be made sinusoidal, trapezoidal, triangular, or have some other more complex shape.

The device can be provided with a means for throwing the ball at different angles to the plane of the panel.

The device can be provided with a means for throwing the ball with different initial velocities.

The device can be provided with a means for throwing the ball at different angles to the plane of the panel and with different initial velocities.

The panel can have an additional corrugation oriented at an angle to the direction of the main corrugation.

The panel can have holes permitting free passage of the ball there through.

### BRIEF DESCRIPTION OF THE DRAWINGS

The invention is explained in:

FIG. 1, which schematically shows one of the options of the proposed device, and in

FIG. 2, which shows an example of the ball trajectory.

### DETAILED DESCRIPTION OF THE PREFERRED EMBODIMENTS

The device comprises a horizontal panel 1 whose working surface is corrugated, and a ball 2, which is part of the claimed device. In the present embodiment, panel 1 is corrugated sinusoidally in two directions, i.e. the panel comprises the main corrugation and the secondary corrugation oriented at an angle to the direction of the main corrugation. In the general case, the corrugations of panel 1 can have any profile—sinusoidal, trapezoidal, triangular (sawtooth) or have some other more complex shapes. The main requirement for corrugation geometry is the presence of areas oriented at an angle to the horizontal plane (the plane of the panel). When using the device as a teaching aid, the panel surface may contain some areas with different parameters of the corrugation, which differ by their geometric dimensions and the shape of the profile. This enhances the demonstration and training potential of the device performance.

Panel 1 can be made in the form of alternating lanes having different geometric parameters of corrugation. The distance between the lanes should not be less than the period of corrugation. In the particular case, some lanes may have no corrugation. For most applications, the number of corrugation periods does not exceed 100.

Regardless of the shape of corrugation, the above-mentioned technical result is achieved, provided that the amplitude of the corrugation and the diameter of ball 2 is not less than 10 times smaller than the corrugation period.

Below, the diameters of ball 2 and the parameters of corrugated panel 1 are given for the case of a sinusoidal corrugation profile.

| | Corrugation period, | Corrugation amplitude, |
|---|---|---|
| Ball diameter, cm | cm | cm |
| 4 | 200 | 3 |
| 2 | 100 | 1 |
| 2 | 30 | 1 |

The device may include the means (not shown) for throwing ball 2 onto panel 1. It is advisable to apply for such means a design, which allows one to throw ball 2 at different initial velocities and angles. It is also advisable to provide the means with a scale permitting the values of the initial velocity and angle to be registered. Such a means is necessary when using the device as a teaching aid in a mechanics course to demonstrate the dynamics of an elastic body moving under the influence of external forces. In the simplest version of this design, a ballistic gun may be used, which is a standard piece of laboratory equipment in physics classrooms. To vary the initial parameters of the trajectory of ball 2 in a wider range, the design can be improved by using a laboratory stand to secure the ballistic gun at a given distance from panel 1.

When using the device for entertainment purposes, the means for throwing ball 2 onto panel 1 is not required. The use of the physical force of the player's hands for throwing ball 2 onto panel 1 contributes to the development of dexterity and an accurate eye.

When using the device for entertainment, panel 1 may also be provided with a plurality of holes (not shown) sized to allow ball 2 to pass there through. When ball 2 hits or misses the hole, the player may score respective points, which may constitute the game strategy.

In a different game strategy, the panel may be made without holes.

Panel 1 and ball 2 should be made of materials with elasticity coefficients permitting for not less than three rebounds of ball 2 from panel 1 when ball 2 is dropped on panel 2 with no initial velocity. This condition is realized when the parts of the device are made of such materials as metal, wood, plastic, or hard rubber.

The invention is based on the analytical analysis of the problem of motion of ball 2 and its collisions with the corrugated surface of panel 2 (provided air resistance is small) and the subsequent numerical simulation.

The nature of the motion of ball 2 is completely determined by four parameters: the amount of energy, the radius of the ball, the period and amplitude of the corrugation. With certain relationships between these parameters, ball 2 may bounce to an integer number of corrugation periods, both from one corrugation minimum to other minima and from one corrugation maximum to other maxima. The increase in each of the four parameters (energy, ball radius, corrugation period or amplitude), all other conditions being equal, increases the relative number of chaotic trajectories, thus reducing the predictability of the system dynamics.

Accounting for energy losses in the system due to weak friction between the air and ball 2 and in its collisions with panel 1 shows that with the small relative magnitude of these losses, the nature of motion remains qualitatively unchanged over some time interval.

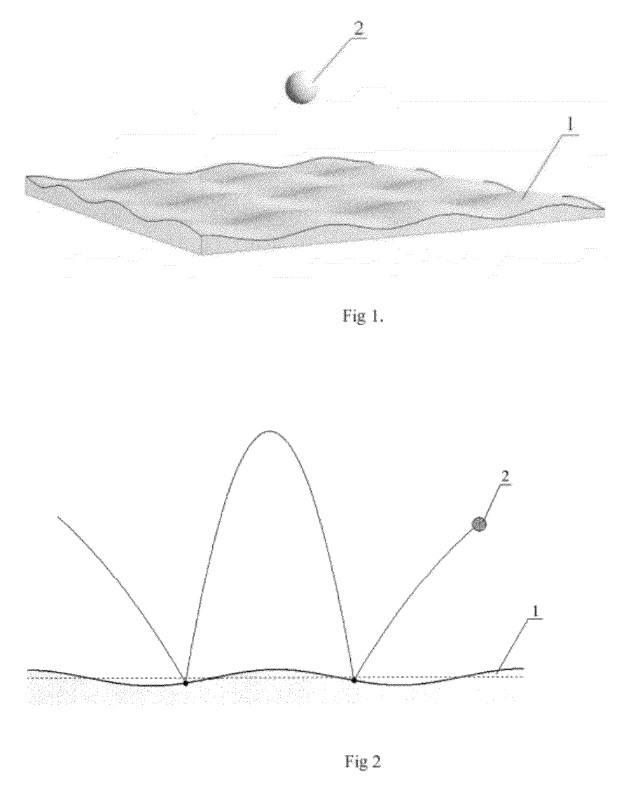

The analysis of the motion of ball 2 for the case when the corrugation of panel 1 is made in two directions (FIG. 1) shows that due to changes in the direction of the rebound of ball 2 from panel 1, which occurs at each collision, this motion acquires a characteristic feature of being similar to random “walks”.

The analysis of the situations described above, and numerical simulations indicate the need for the following condition to be satisfied: the corrugation amplitude and the diameter of ball 2 must be at least 10 times less than the corrugation period.

Cognitive, educational or entertainment properties of the device are realized by throwing ball 2 onto panel 1.

Ball 2 moves in a gravitational field and undergoes multiple collisions with panel 1. Due to the corrugation of the surface of panel 1 and ball 2 rotation about its axis, the angle of its rebound from panel 1 differs from the angle of incidence, therefore every time after the collision, the parameters of the trajectory of ball 2 will change. Provided that air resistance is small, the trajectory of ball 2 is close to parabolic.

This description does not limit other possible implementations of the panel and the means for throwing the ball.

What is claimed is:

1. A device for training and games comprising a panel and a ball, wherein the panel is in the form of a periodic corrugation with an amplitude which is at least 10 times less than its period, and the ball has a diameter which is at least 10 times smaller than the period of corrugation.

2. The device of claim 1 wherein the surface corrugation can be made sinuisoidal, trapezoidal, triangular, or can have a more complex forms.

3. The device of claim 1 comprising means for throwing the ball at different angles to the plane of the panel.

4. The device of claim 1 comprising means for throwing the ball at different initial velocities.

5. The device of claim 1 comprising means for throwing the ball at different angles to the plane of the panel and at different initial velocities

6. The device of claim 1, wherein the panel is made with an additional corrugation oriented at an angle to the direction of the main corrugation.

7. The device of claim 1, wherein the panel has a plurality of holes sized to allow a single ball to pass there through.
